(19) United States
(12) Patent Application Publication
(10) Pub. No.: US 2008/0109653 A1
(43) Pub. Date: May 8, 2008

(54) INFORMATION-PROCESSING APPARATUS, INFORMATION-PROCESSING METHOD, AND COMMUNICATION CONTROL PROGRAM RECORDING MEDIUM

(75) Inventor: Tatsuhiko Yokohama, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/764,961

(22) Filed: Jun. 19, 2007

(30) Foreign Application Priority Data
Nov. 6, 2006 (JP) 2006299850

(51) Int. Cl. H04L 9/00

(52) U.S. Cl. 713/156

(57) ABSTRACT

An information-processing apparatus includes a designation section that designates a request format for receiving a supply of information from a supplier of validity information of a public key certificate, and a corresponding response format; a response result acquirer that transmits to the supplier an inquiry for validity information of a public key certificate according to the request format, and acquires a response result; a validity confirmation section that confirms validity of the inquired public key certificate on the basis of the validity information included in the response result; and a redesignation section that redesignates the request format or the response format on the basis of a comparison between the response result and the response format.

### CROSS-REFERENCE TO RELATED APPLICATIONS

This application is based on and claims priority under 35 USC 119 from Japanese Patent Application No. 2006-299850, filed on Nov. 6, 2006.

### BACKGROUND

1. Technical Field

The present invention relates to an information-processing apparatus, an information-processing method, and a communication control program recording medium.

2. Related Art

Techniques for performing online verification (verification via communication lines) of the validity of a public key certificate have been put into practice. Typically, the OCSP (Online Certificate Status Protocol) standard defined in RFC (Request For Comments) 2560 is employed for online verification. According to the OCSP, the standard is not strictly determined, such that a person implementing the OCSP can determine the specifications with some degree of freedom.

### SUMMARY

According to an aspect of the present invention, there is provided an information-processing apparatus including a designation section that designates a request format for receiving a supply of information from a supplier of validity information of a public key certificate, and a corresponding response format; a response result acquirer that transmits to the supplier an inquiry for validity information of a public key certificate in accordance with the request format, and acquires a response result; a validity confirmation section that confirms validity of the inquired public key certificate from the validity information included in the response result; and a redesignation section that redesignates the request format or the response format in accordance with a comparison between the response result and the response format.

### BRIEF DESCRIPTION OF THE DRAWINGS

Exemplary embodiments of the present invention will be described by reference to the following figures, wherein:

FIG. 1 is a block diagram showing an example hardware configuration of a certificate verification system;

FIG. 2 is a block diagram showing an example functional configuration of a certificate verification system;

FIG. 3 is a diagram showing example correlation information;

FIG. 4 is a flowchart showing example processing performed at a client;

FIG. 5 is a schematic diagram showing an example correlation relationship between request data and response data along a time sequence;

FIG. 6 is a schematic diagram showing an example correlation relationship between request data and response data along a time sequence; and

FIG. 7 is a schematic diagram showing example response data along a time sequence.

### DETAILED DESCRIPTION

An exemplary embodiment of the present invention is next described.

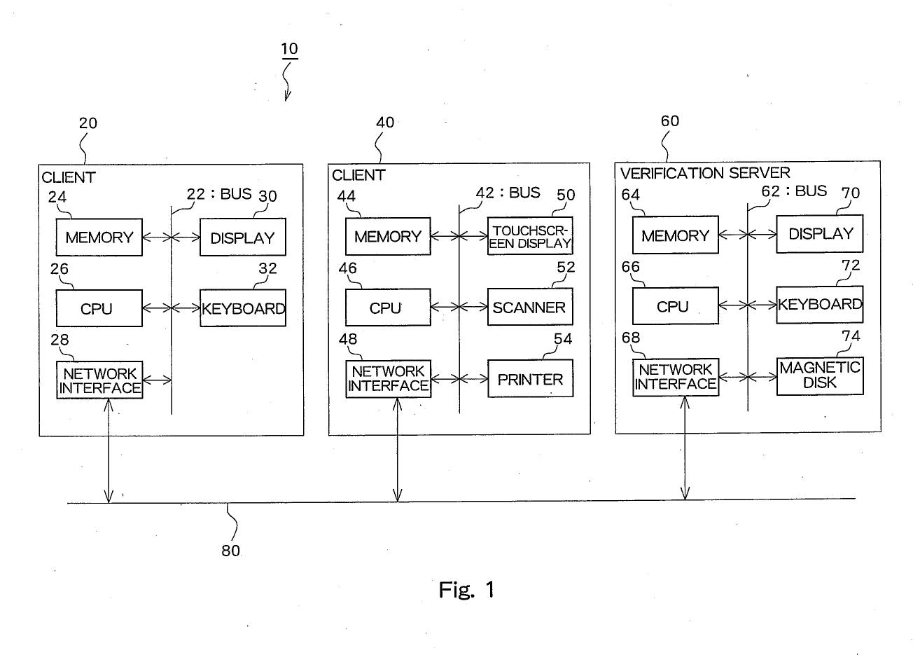

FIG. 1 is a block diagram for explaining an outline of a hardware (physical entity such as devices) configuration of a certificate verification system 10 according to an exemplary embodiment of the present invention. The certificate verification system 10 is a system for performing online confirmation of validity of a public key certificate by reference to the OCSP standard or a unique standard. The certificate verification system 10 as shown includes clients (apparatuses on the inquiring side) 20, 40 that transmit an inquiry regarding validity of a public key certificate, and a verification server (apparatus on the responding side) 60 that provides a response regarding validity of a public key certificate, which are communicably connected via a network (communication network) 80 such as the Internet or a telephone line.

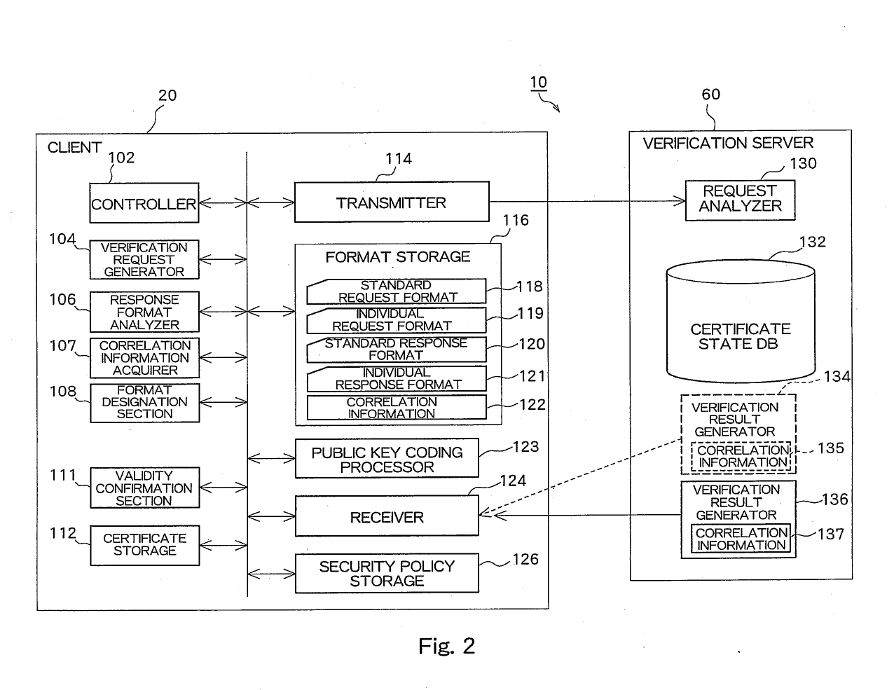

The client 20 is constituted from a general-purpose information processing device such as a PC (personal computer). More specifically, the client 20 includes a bus 22 that serves as a communication path. Connected to the bus 22 are devices such as a memory (storage device) 24 composed of a semiconductor memory, a magnetic disk, or the like, a CPU (central processing unit) 26 having a computational control function, a network interface 28 that carries out communication with an external apparatus via the network 80, a display device 30 that provides an image display, and a keyboard 32 that receives user inputs. In the client 20, operations of the CPU 26 are defined by a program installed in the memory 24. As a result, as shown in FIG. 2, various processing functions are configured in the CPU 26, and, under the control of the CPU 26, various processing functions are configured also in the respective hardware components. Installation of the program may be performed during the stage of manufacture of the client 20, or may alternatively be performed after completion of manufacture, via a recording medium or the network 80. In other words, the program may be supplied by means of a recording medium such as a CD-ROM or via a website or the like, and be installed by reading signals transmitted therefrom.

The client 40 is an information-processing apparatus having various image-processing functions, and may be referred to as an image-processing apparatus. Similar to the client 20, the client 40 includes a bus 42. A memory 44, a CPU 46, and a network interface 48 are connected to the bus 42. Further connected to the bus 42 are a touchscreen display 50 which is a display device having an input function by screen contact, a scanner (reading device) 52 that optically reads off of a sheet and generates an image data, and a printer (printing device) 54 that performs printing on a sheet on the basis of the image data. In the client 40, it is possible to individually operate the scanner 52, the printer 54, or the like. The client 40 has functions such as a function of transmitting by e-mail or facsimile image data generated by the scanner 52, via the network interface 48; a function of printing image data received via e-mail or facsimile using the printer 54; and a copy function achieved by cooperative operation of the scanner 52 and the printer 54. The client 40 may be referred to as a multi-function machine, in view that the client 40 has these multiple image-processing functions.

The verification server 60 is an information-processing apparatus having a high-speed information-processing function and a large-capacity data storage function. Similar to the client 20, the verification server 60 includes a bus 62. Connected to the bus 62 are a memory 64, a CPU 66, a network interface 68, a display 70, and a keyboard 72. Furthermore, a large-capacity magnetic disk 74 is also connected to the bus 62.

Next, the functional configuration of the certificate verification system 10 is described by reference to FIG. 2. In FIG. 2, the client 40 is not shown.

The client 20 is configured to include the respective functional components of a controller 102, a verification request generator 104, a response format analyzer 106, a correlation information acquirer 107, a format-designating section 108, a validity confirmation section 111, certificate storage 112, a transmitter 114, format storage 116, a public key coding processor 123, a receiver 124, and security policy storage 126.

The controller 102 serves to control the respective functional components. The verification request generator 104 generates request data for requesting confirmation of the validity of a public key certificate. During generation of the request data, reference is made to data regarding a request format stored in the format storage 116, and attachment of an electronic signature is carried out by the public key coding processor 123. The response format analyzer 106 compares data regarding a response format stored in the format storage 116 with a format of response data, and determines a difference between the two. There are cases in which response data includes a notice of a format deficiency notified by the verification server 60, and, in such a case, the response format analyzer 106 can extract the notice of format deficiency.

The correlation information acquirer 107 is an example form of a combination information acquirer, and serves to acquire, from the verification server 60, information regarding correlation between a request format and a response format employed in the verification server 60. Typically, the correlation information acquirer 107 acquires “correlation information” which is information regarding combinations of request formats and response formats employed in the verification server 60, and stores the acquired information in the format storage 116. However, the correlation information acquirer 107 may alternatively transmit an inquiry to the verification server after identifying a response format, and acquire information regarding a request format necessary for acquiring a verification result in accordance with the identified response format.

The format designating section 108 is an example form of a designation and redesignation section, and serves not only to designate a format in the format storage 116 when there is a format that has yet to be designated, but also to change a format stored in the format storage 116, on the basis of an analysis result of the response format analyzer 106. The change of format is typically performed in accordance with a result obtained by causing the correlation information acquirer 107 to acquire information. In an exemplary embodiment in which the correlation information acquirer 107 acquires correlation information, the format designation section 108 searches in the acquired correlation information for a request format corresponding to a desired response format. Meanwhile, when it is desired to employ a particular response format (which is designated in advance, for example), it is possible to cause the correlation information acquirer 107 to acquire information of a request format corresponding to that response format. When a notice of format deficiency notified by the verification server 60 is extracted by the response format analyzer 106, the format designation section 108 determines a format change so as to correct the format deficiency.

The validity confirmation section 111 confirms validity of a public key certificate on the basis of a verification result indicated in response data. The certificate storage 112 stores various public key certificates issued by authentication authorities. The transmitter 114 transmits a request data generated by the verification request generator 104 to the verification server 60.

The format storage 116 stores a standard request format 118 and an individual request format 119 that are referred to by the verification request generator 104 when generating request data. The standard request format 118 is a format used when generating request data addressed to a verification server which employs a normal format, and is designated at the time of, for example, configuring the client 20. The individual request format 119 is a format used when generating a request data addressed to a verification server which employs a format that differs from a normal format, and is designated by the format designation section 108. The format storage 116 further stores a standard response format 120 and an individual response format 121 that are used by the response format analyzer 106 for comparison with a format of response data. The standard response format 120 is a format used for performing comparison with respect to response data obtained from a verification server which employs a normal format, and is designated at the time of, for example, configuring the client 20. The individual response format 121 is a format used for performing comparison with respect to response data obtained from a verification server which employs a format that differs from a normal format, and is designated by the format designation section 108. The individual response format 121 is often designated in combination with the individual request format 119. In other words, when response data is obtained by generating and transmitting request data in accordance with the individual request format 119, a corresponding individual response format 121 is often used to perform the format comparison. The term “format” referred to herein includes features such as a format defining entries to be included in a data and descriptions in those entries, use or non-use of a signature and encryption, a coding scheme defining the algorithms of the signature and encryption, and a communication scheme defining the communication protocol used for data transmission and reception.

The format storage 116 can further store correlation information 122. The correlation information 122 is information acquired by the correlation information acquirer 107, and indicates combinations of request formats and response formats that can be employed in the verification server 60.

The public key coding processor 123 serves to, on the basis of a public key encryption scheme, encrypt request data to be transmitted and to attach a signature to the request data, as well as to decrypt received response data and to verify a signature placed thereon. In performing these processes, a public key certificate stored in the certificate storage 112 is employed when necessary. The receiver 124 receives response data from the verification server 60. The security policy storage 126 stores a security policy designated for the client 20. A security policy is a standard that defines security measures. Example settings of security policy include placement of a restriction with regard to a communication destination or a communication protocol, and placement of a restriction with regards to execution or processing of externally-acquired data.

Configured within the verification server 60 shown in FIG. 2 are a request analyzer 130, a certificate state DB (database) 132, and verification result generators 134, 136. The request analyzer 130 analyzes request data received from the transmitter 114 of the client 20. During the analysis, processes such as extraction of a public key certificate to be verified are performed while assuming that the received request data are configured in a predetermined format. The certificate state DB 132 is a database which stores validity information of the respective public key certificates handled by this verification server 60.

The verification result generator 134 acquires from the certificate state DB 132 validity information of the public key certificate to be verified, and generates response data. The verification result generator 134 includes correlation information 135 stored therein. The correlation information 135 is information indicating combinations of request formats and response formats employed in the verification server 60. In other words, combinations are designated in the correlation information 135 to define which response format is to be used in generating response data upon receipt of request data according to each request format. The verification result generator 134 generates response data in accordance with a format designated in the correlation information 135, and transmits the generated data to the client 20. While the specifications employed in the correlation information are basically fixed over a long period of time, the specifications may be changed for technical reasons or operational reasons. In FIG. 2, due to format changes, the verification result generator 136 having the settings of new correlation information 137 is configured as a replacement for the verification result generator 134. A change in correlation information may be a change of a response format used for generating response data, or may be a change of a request format defining the format of acceptable request data.

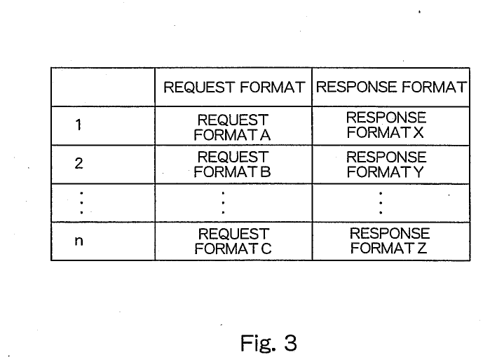

An example of the correlation information is explained by reference to FIG. 3. FIG. 3 is a diagram showing an example of correlation information 135, 137 stored in the verification server 60 and correlation information 122 stored in the client 20 shown in FIG. 2. In the correlation information illustrated in FIG. 3, n combinations of request formats and response formats are designated. More specifically, with respect to request formats A, B, . . . C, response formats X, Y, . . . Z, are designated, respectively. In other words, there are provided settings defining that, in response to request data generated in accordance with request formats A, B, . . . C, response data should be generated in accordance with response formats X, Y, . . . Z, respectively.

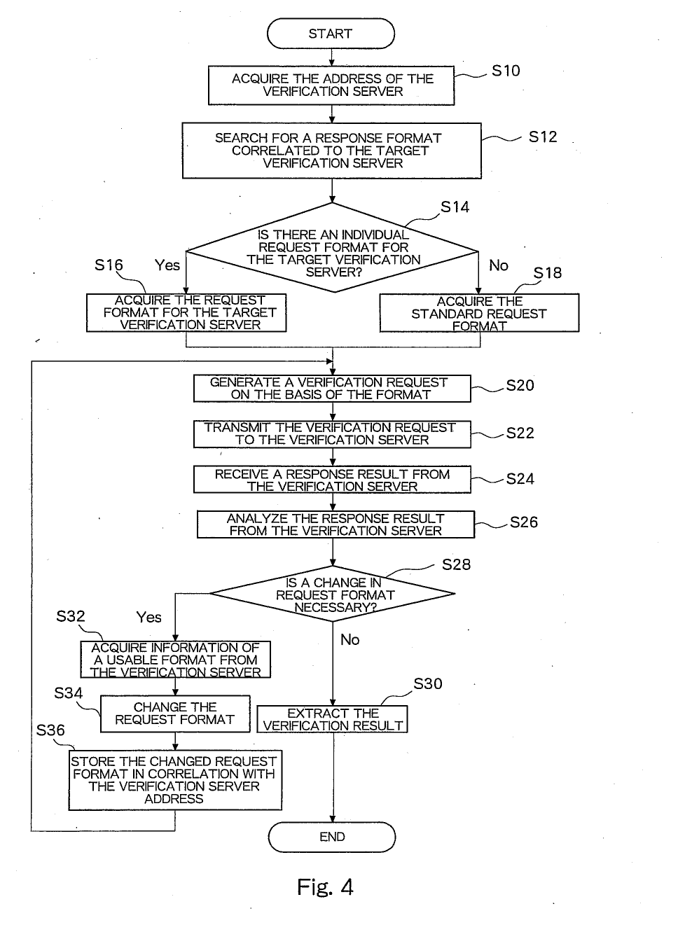

Next, operations of the certificate verification system 10 shown in FIG. 2 are described by reference to the flowchart of FIG. 4.

There are cases in which, when the client 20 uses a public key certificate stored within the certificate storage 112, the client 20 transmits an inquiry to the verification server 60 regarding whether or not the public key certificate has expired. For example, when an encrypted transmission of an e-mail is to be carried out in accordance with a user instruction, there is transmitted an inquiry regarding validity of a public key certificate to be used for the encryption. In order to execute the inquiry, the verification request generator 104 reads descriptions of the public key certificate, and acquires a URL (information that identifies a communication destination in the network, such as an address in the network) of the verification server 60 (S10). In general, an authentication authority that issues a public key certificate provides a verification server for supplying the latest validity information of the public key certificate, and a URL of the verification server is indicated within the public key certificate. The inquired validity information is typically in the form of expiration information (or information indicating validity) denoting whether or not the certificate has expired (or whether or not the certificate is still valid). However, inquired validity information may alternatively be in the form of expiration term information (or validity term information) denoting when the certificate expires (or the time until the certificate is valid).

The verification request generator 104 searches in the format storage 116 for a request format correlated to the acquired URL (S12). Specifically, the verification request generator 104 checks whether any individual request format 119 stored in the format storage 116 corresponds to the request format of the verification server to which the inquiry is to be transmitted (S14). When the request format of the verification server is found in the format storage 116, this request format is acquired (S16). On the other hand, when the request format is not found, the standard request format 118 is acquired (S18). The verification request generator 104 then generates request data for requesting verification in accordance with the acquired request format (S20). During generation of the request data, in a case where attachment of an electronic signature is required by the request format, an electronic signature is attached to the request data by the public key coding processor 123. The generated request data is transmitted from the transmitter 114 to the verification server 60 (S22).

In the verification server 60, the request analyzer 130 analyzes the received request data to verify the signature, to judge whether the format of the request data is acceptable, and to identify the public key certificate for which verification is requested. When the format of the request data is acceptable, the verification result generator 134 (or 136) reads out validity information from the certificate state DB 132 to thereby generate response data, and transmits the generated data to the client 20. On the other hand, when the format of the request data is unacceptable, the verification result generator 134 generates response data which, instead of including the validity information, notifies that the request format is deficient, and transmits the generated data to the client 20.

In the client 20, the receiver 124 receives the response data from the verification server 60 (S24). With respect to the received response data, after the public key coding processor 123 performs signature verification, the response format analyzer 106 performs analysis (S26). During this analysis, the response format analyzer 106 first searches in the format storage 116 for a response format corresponding to the request format used for the generation of the request data. More specifically, the standard response format 120 is searched for the time of generation of the request data in accordance with the standard request format 118, whereas, when an individual request format 119 correlated to the verification server was used, the corresponding individual response format 121 is searched for. Subsequently, the format of the response data is compared with the searched and retrieved response format.

As a result of the comparison, when the format of the response data is found to match the retrieved response format or to be very similar to the response format (i.e., differing only within a range of tolerance), the format of the response data is judged as conforming. On the basis of this comparison result, it is further possible to evaluate that the reliability of the response data is high. On the other hand, when, as a result of the comparison, the format of the response data is found not to match the retrieved response format or to be dissimilar to the response format (i.e., differing beyond the range of tolerance), the format of the response data is judged as non-conforming. In this case, for example, the response data itself can be evaluated as reliable on the basis that the separately-performed signature verification was successful, and therefore the acquired validity information can be treated as reliable information. Alternatively, it is also possible to place high importance on the non-conformity of format, and therefore negatively evaluate the reliability of the response data and refuse to accept the acquired validity information.

An example case in which the format of the request data is judged as non-conforming is a case in which a verification request is transmitted for the first time to a certain verification server, and this verification server employs a unique format. In this case, there is a high possibility that processing cannot be carried out using the standard request format and the standard response format, and that the format of the response data would be judged as non-conforming. Also, in a case in which a format change is made in a verification server with which processing could previously be performed, the format of the response data would be changed, such that the format of the response data would likely be judged as non-conforming. Furthermore, the format of the response data would be judged as non-conforming also when the response data include no verification result and instead include a notification indicating that the request format includes a deficiency.

On the basis of these analysis results, the response format analyzer 106 judges whether a change in the request format is necessary (S28). When no change in the request format is necessary, the processing flow is ended after the validity confirmation section 111 extracts the validity information included in the response data (S30). However, there are also cases in which the response format analyzer 106 judges that no change in the request format is necessary but a change in the response format is required. In such a case, the format designation section 108 generates, as an individual response format 121 in the format storage 116, a response format corresponding to the verification server. It should be noted that, even when a change in request format is judged necessary, the processing flow is ended without implementing any format changes when a suitable candidate format into which the change should be made cannot be found or when no candidates at all exist.

On the other hand, when it is judged in S28 that a change in the request format is necessary, a change in the request format is implemented. More specifically, the correlation information acquirer 107 acquires the correlation information (including the change) 137 from the verification server 60, and stores the acquired information as the correlation information 122 into the format storage 116 (S32). Further, the format designation section 108 searches in the correlation information 122 to identify a request format corresponding to a desired response format (for example, the current response format), and designates the identified request format as a new request format (S34). The format designation section 108 also changes a response format as necessary. The changed request and response formats are correlated to the URL of the verification server and stored in the format storage 116 (S36). It is possible to store only the difference with respect to the standard format so as to reduce the amount to be stored. The client 20 repeats the processing from S20 onward in accordance with the changed format.

The above-described processing flow is described as below when explained with reference to the exemplary correlation information shown in FIG. 3. First, for example, when an inquiry was made by transmitting request data in accordance with request format A, response data having response format Y has conventionally been returned. However, after the point when the verification server newly employs the correlation information shown as an example in FIG. 3, a response data having response format X is returned with respect to a request data in accordance with request format A. Under this situation, the client acquires the correlation information of FIG. 3 from the verification server, and performs a search as to which request format should be used in order to obtain response data having response format Y. As a result, it is found that request format B should be used, and a change from request format A to request format B is made. Instead of acquiring the correlation information, the client may alternatively directly transmit an inquiry to the verification server as to which request format should be used in order to obtain response data having response format Y.

There may be cases in which multiple request formats are designated with respect to a single response format. In such a case, the format designation section 108 must select which one of the request formats is to be used. Further, in a case in which the current response format becomes unusable, the format designation section 108 must select which one of the response formats (and the request formats) is to be used. A condition for such selection can be set in various manners. For example, the selection condition may be random selection, or alternatively, the selection condition may be such that the selection is performed in accordance with a sequence of arrangement within the correlation information. Further, the selection condition may be set so as to designate that the security policy stored in the security policy storage 126 is referred to and format changes which fail to satisfy the security policy are not performed. A specific example of this is an arrangement in which the security policy always requires a signature at the time of transmission, and, accordingly, response formats which do not include an attached signature are eliminated from the candidates.

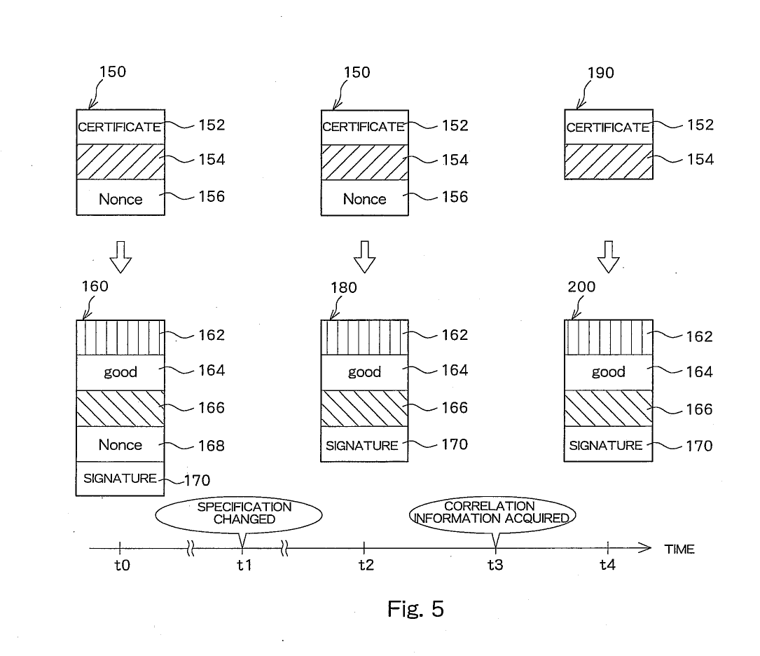

Next, examples of format changes are described by reference to FIGS. 5-7.

FIG. 5 is a schematic diagram showing request data and response data at respective points in time, with time given on the horizontal axis. In FIG. 5, at time t0, request data 150 are transmitted from the client 20 to the verification server 60. The request data 150 are generated in accordance with the request format designated in the client 20 at that point, and include an entry 152 identifying the public key certificate for which validity confirmation is requested, an entry 154 describing other items, and an entry 156 for the Nonce setting. Among these entries, entries 152 and 154 are mandatory entries that must be provided, whereas entry 156 is an arbitrary entry that is acceptable by the verification server 60.

The verification server accepts the request data 150 and generates response data 160. The response data 160 include entries 162, 164, 166, 168, and 170. Among these entries, entries 162-166 and 170 are mandatory entries. For example, entry 164 indicates that validity of the public key certificate is “good (valid),” and, in entry 170, a signature for preventing tampering of the response data 160 is attached. Meanwhile, entry 168 is an arbitrary entry which is provided when the request data 150 include the Nonce entry 156. In entry 168, the Nonce value of entry 156 is copied without any change. In other words, entry 168 is an entry used for evidencing that the response data 160 are generated after acceptance of the request data 150.

In the client 20, after verifying the signature and confirming that the signature has not been tampered with, a comparison of response formats is performed so as to judge format conformity. In the illustrated example, because the client 20 transmitted the request data including the Nonce entry 156, confirmation is made as to whether there are returned the response data including the Nonce entry 168 (and whether the received Nonce value matches the transmitted Nonce value). Various degrees of accuracy can be set for the format comparison. For example, the comparison may be performed to confirm whether or not all of entries 162-170 are properly included. In other words, a detailed comparison may be performed to confirm whether or not a deviation or change from the expected response format is found.

Because the verification server 60 must generate the response data 160 in real time after receiving the request from the client 20 and reading the Nonce value, when many requests are received within a short period of time, an undesirable increase in the load of the verification server 60 occurs. In such a situation, at time t1, the verification server 60 suddenly changes its specification so as not to support Nonce. In other words, the specification is changed such that, even if a Nonce entry is included in the request data, no Nonce entry (or a Nonce entry having a fixed value) would be included in the response data. According to this change, the verification server 60 is enabled to generate response data in advance before receiving a request for validity confirmation from the client 20. This type of specification change is not a fictitious feature, and has actually been implemented in a well-known commercial OCSP server.

Subsequently, at time t2, the client 20 transmits to the verification server 60 request data 150 which are identical to the request data sent at time t0. In response, the verification server 60 ignores the Nonce entry 156 in the request data 150 and generates response data 180. In other words, the response data 180 only include entries 162-166 and 170 and do not include the Nonce entry 168.

In the client 20, when the response data 180 are received, although the signature verification is successful, the response format is determined as non-conforming. In this situation, the client 20 does not immediately prompt the user to provide an instruction, but attempts to solve the problem in accordance with programmed settings. The client 20 first determines that the response data 180 do not include the Nonce entry 168, and then attempts to change the format setting related to the Nonce entry 168. Specifically, at time t3, the client 20 acquires correlation information from the verification server 60, and searches for a request format that would enable inclusion of the Nonce entry 168 in the response format. However, in the example of FIG. 5, no request format that would include the Nonce entry 168 in the response format is found. At this point, the client 20 decides to employ a response format that does not include the Nonce entry 168, and searches in the correlation information for a request format corresponding to the response format. As a result, it is found that the request format may or may not include the Nonce entry 156. Accordingly, in this example, the client 20 selects to use the request format that does not include the Nonce entry 156 in accordance with a setting designating to not include any unnecessary entries.

At time t4, the client transmits request data 190 in accordance with the changed request format for validity confirmation of the same public key certificate. As the request data 190 does not include the Nonce entry 156, without the need to ignore any Nonce entry, the verification server 60 generates response data 200 composed of entries 162-166 and 170. With respect to this response data 200, the client. 20 performs comparison using the changed response format which does not include the Nonce entry. As a result, the format of the response data 200 is determined as conforming to the response format.

The processes such as the redesignation of the request format including acquiring of the correlation information and the retransmission of the request data can be performed immediately after carrying out the format comparison with respect to the previous response data 180. Particularly when a negative evaluation was made with respect to the reliability of the previous response data 180 and the validity information indicated in the response data 180 was not employed, it is desirable to obtain a reliable response data as soon as possible. However, for example, there may be cases where the reliability of the response data 180 is not denied even when there exists a format non-conformity in the response data 180, and, on the basis of the success of signature verification or the like, the validity information included in the previous response data 180 is employed. In such a case, the redesignation of the request format and the retransmission of the request data may be performed after elapse of a relatively long time from time t2.

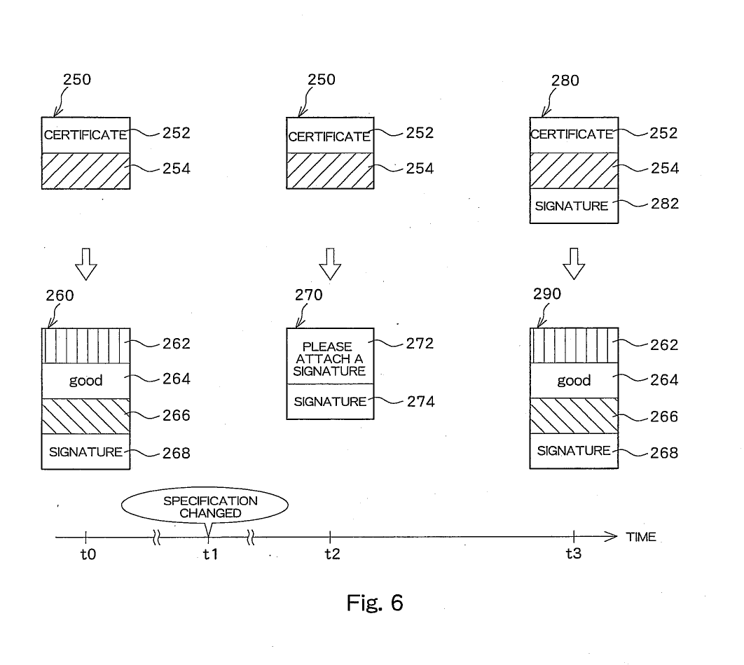

FIG. 6 is a diagram similar to FIG. 5, and schematically shows a request data and a response data at respective points in time, with time given on the horizontal axis. At time t0 in FIG. 6, the client 20 transmits request data 250 to the verification server 60. The request data 250 includes an entry 252 identifying a certificate, and an entry 254 describing other items.

The verification server 60 accepts the request data 250 and transmits response data 260. The response data 260 include entries 262, 264, 266, and 268. For example, entry 264 indicates that validity of the public key certificate is “good (valid),” and, in entry 268, a signature for preventing tampering of the response data 260 is attached. The format of the response data 260 is a response format expected by the client 20.

At time t1, a specification change is made in the verification server 60 so as to accept only request data having a signature attached thereto. Accordingly, at subsequent time t2, when the client 20 transmits the request data 250, the verification server 60 sends back response data 270 that do not include the validity information. The response data 270 are composed of an entry 272 of advice information indicating “please attach a signature,” and an entry 274 attaching a signature.

The client 20 analyzes the response data 270, and determines that the response data 270 have a format different from the expected response format and include no validity information. In this situation, the client 20 does not proceed to display an error message indicating “verification failed due to some reasons” or the like, but attempts to recover from the error in accordance with programmed settings. Specifically, at time t3, the client 20 immediately changes the request format in accordance with the indication in entry 272, and transmits request data 280 having the signature entry 282 attached in accordance with the changed request format. The verification server 60 accepts the request data 280 including the signature, and transmits response data 290 composed of the entries 262-268 identical with those of the response data 260 transmitted at time t0. As no validity information is included in the response data 270 received at time t2, time t3 at which the change of request format and the request retransmission are performed is typically set immediately after time t2.

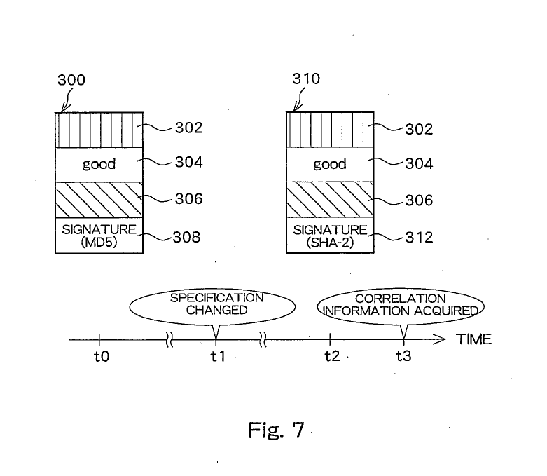

FIG. 7 is similar to FIGS. 5 and 6 in that time is given on the horizontal axis. FIG. 7 shows only response data, without showing request data. In this example, at time t0, response data 300 is transmitted from the verification server 60 to the client 20. The response data 300 include entries 302, 304, 306, and 308. Entry 304 indicates that validity of the public key certificate is “good (valid),” and, in entry 308, a signature for preventing tampering of the response data 300 is attached. This signature is generated in accordance with an algorithm using a hash function called MD5 (Message Digest 5).

At time t1, the verification server 60 changes its specification so as to employ a hash function called SHA-2 (Secure Hash Algorithm 2) as the signature algorithm instead of MD5. At subsequent time t2, the verification server 60 transmits response data 310 in response to an inquiry from the client 20. This response data 310 includes entries 302, 304, 306, and 312. In other words, the response data 310 differ from the response data 300 in that the signature entry 312 in accordance with SHA-2 is provided instead of the signature entry 308 in accordance with MD5.

The client 20 determines that the format of the response data 310 includes a signature generated by an unexpected algorithm. Accordingly, at time t3, the client 20 acquires the correlation information from the verification server 60, and searches for a request format to be used for receiving response data having the same format as the conventional response data 300. However, because such a request format cannot be found in this example, there is a necessity to change the acceptable response format. In this situation, the client 20 attempts to employ the conventional request format, and confirms whether the response format of the response data 310 satisfies the security policy set in the security policy storage 126. In the illustrated example, it is assumed that SHA-2 is defined as an acceptable hash function, such that the client 20 redesignates the response format so as to recognize response data including a signature according to SHA-2 as a normal response. In this example, because the same response data 310 would be obtained when a request data is newly transmitted, retransmission of response data is unnecessary; the only requirement is to simply accept the already-received response data 310.

Although the above description refers to the case in which the client of the certificate verification system 10 is the client 20 composed of a general-purpose information-processing device such as a PC, any information-processing device having a communication function and an arithmetic function can generally serve as a client of the certificate verification system 10. For example, the client 40 in the form of an image-processing apparatus shown in FIG. 1 can operate as a client of the certificate verification system 10, so long as the client 40 is configured to include functions similar to those of the client 20. In the client 40, it is additionally possible to perform a series of processing in cooperation with the scanner 52 and the printer 54. For example, when image data generated in the scanner are to be transmitted via an encrypted e-mail, a series of processing including image data generation, validity confirmation of the public key certificate, validity reconfirmation in accordance with a format change in the verification server, encryption using the validity-confirmed public key certificate, and e-mail transmission can be executed without requiring a user instruction in between.

Further, the client of the certificate verification system 10 may alternatively be configured as a distributed processing system including multiple communicable computer hardware components. According to one example of function distribution, a system is configured by separately providing a computer that analyzes validity information included in response data to thereby confirm validity, and a computer that compares an expected response format and the format of the response data.

According to the above description, when a format non-conformity is detected in response data from a verification server, the client changes its setting of a request format or a response format for that verification server. According to this arrangement, the changed request or response format is employed in the client for all subsequent inquiries made with respect to that verification server, including inquires in which the same user requests validity confirmation of a different public key certificate and in which a different user requests validity confirmation of the same or a different public key certificate.

However, there may be cases in which a verification server provides different responses to the client depending on the users that transmitted the validity confirmation requests. In one example, when a deficiency is found in a public key certificate of a user who transmitted a validity confirmation request, the verification server can provide a response different from a normal response with respect to a subsequent request (typically, a request for validity confirmation of a different public key certificate) from that specific user. Accordingly, it may not be necessary for the client to uniformly change a request or response format for the overall verification server.

For example, it may be effective to employ a configuration such that, when a format non-conformity is detected in response data provided in response to a request, the client initially redesignates the request format or the response format for application to only the user who transmitted the request, and subsequently at a point after similar format non-conformities are detected for a predetermined number of users (for example, two or three different users), the client applies the redesignated result to all users. Furthermore, there can be cases in which a user owns multiple types of public key certificates within a client, and a format non-conformity is detected in response data provided in response to a verification confirmation request generated using the user's public key certificate of one type. In such a case, it may be effective to employ a configuration such that the client initially redesignates the request format or the response format for application to only that specific public key certificate of the user, and subsequently at a point after similar format non-conformities are detected for a predetermined number of different public key certificates owned by the user, the client applies the redesignated result to all public key certificates employed by that user.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An information-processing apparatus comprising:
a designating section that designates a request format for receiving a supply of information from a supplier of validity information of a public key certificate, and a corresponding response format;
a response result acquirer that transmits to the supplier an inquiry for validity information of a public key certificate in accordance with the request format, and acquires a response result;
a validity confirmation section that confirms validity of the inquired public key certificate on the basis of the validity information included in the response result; and
a redesignation section that redesignates the request format or the response format on the basis of a comparison between the response result and the response format.

2. The information-processing apparatus as defined in claim 1, further comprising:
a combination information acquirer that transmits an inquiry to the supplier and acquires combination information indicating a combination of a request format acceptable by the supplier and a response format according to which the supplier supplies information in response to that request format.

3. The information-processing apparatus as defined in claim 2, wherein
when it is determined as a result of the comparison that the response result does not satisfy the response format, the redesignation section redesignates the request format or the response format on the basis of the combination information.

4. The information-processing apparatus as defined in claim 1, further comprising:
a request format information acquirer that transmits an inquiry to the supplier and acquires a request format information regarding a request format necessary for acquiring a response result having a specific response format.

5. The information-processing apparatus as defined in claim 4, wherein
when it is determined as a result of the comparison that the response result does not satisfy the response format, the redesignation section redesignates at least the request format on the basis of the request format information.

6. The information-processing apparatus as defined in claim 1, further comprising:
storage that stores a standard request format or standard response format to be employed with respect to the supplier in general, as well as an individual request format or individual response format corresponding to the redesignated request or response format redesignated by the redesignation section; wherein
the designation section designates the request format or the response format in accordance with the standard request format or the standard response format when an individual request format or individual response format for use with respect to the supplier is not stored in the storage, whereas, when an individual request format or individual response format for use with respect to the supplier is stored in the storage, the designating section designates the request format or the response format in accordance with the stored individual request or response format.

7. An information-processing method comprising:
designating a request format for receiving a supply of information from a supplier of validity information of a public key certificate, and a corresponding response format;
transmitting to the supplier an inquiry for validity information of a public key certificate in accordance with the request format, to thereby acquire a response result;
confirming validity of the inquired public key certificate on the basis of the validity information included in the response result; and
redesignating the request format or the response format on the basis of a comparison between the response result and the response format.

8. The information-processing method as defined in claim 7, further comprising:
transmitting an inquiry to the supplier to thereby acquire combination information indicating a combination of a request format acceptable by the supplier and a response format according to which the supplier supplies information in response to that request format.

9. The information-processing method as defined in claim 8, wherein
during the redesignation, when it is determined as a result of the comparison that the response result does not satisfy the response format, the request format or the response format is redesignated on the basis of the combination information.

10. The information-processing method as defined in claim 7, further comprising:
transmitting an inquiry to the supplier to thereby acquire request format information regarding a request format necessary for acquiring a response result having a specific response format.

11. The information-processing method as defined in claim 10, wherein
during the redesignation, when it is determined as a result of the comparison that the response result does not satisfy the response format, at least the request format is redesignated on the basis of the request format information.

12. The information-processing method as defined in claim 7, further comprising:
storing a standard request format or standard response format to be employed with respect to the supplier in general, as well as an individual request format or individual response format corresponding to the redesignated request or response format redesignated by the redesignation section; wherein
during the designation, the request format or the response format is designated in accordance with the standard request format or the standard response format when an individual request format or individual response format for use with respect to the supplier is not stored in the storage, whereas, when an individual request format or individual response format for use with respect to the supplier is stored in the storage, the request format or the response format is designated in accordance with the stored individual request or response format.

13. A computer-readable medium storing a program causing a computer to execute a process for communication control, the process comprising:
designating a request format for receiving a supply of information from a supplier of validity information of a public key certificate, and a corresponding response format;
transmitting to the supplier an inquiry for validity information of a public key certificate in accordance with the request format, to thereby acquire a response result;
confirming validity of the inquired public key certificate on the basis of the validity information included in the response result; and
redesignating the request format or the response format on the basis of a comparison between the response result and the response format.

14. The medium as defined in claim 13, wherein the process further comprises:
transmitting an inquiry to the supplier to thereby acquire combination information indicating a combination of a request format acceptable by the supplier and a response format according to which the supplier supplies information in response to that request format.

15. The medium as defined in claim 14, wherein
during the redesignation, when it is determined as a result of the comparison that the response result does not satisfy the response format, the request format or the response format is redesignated on the basis of the combination information.

16. The medium as defined in claim 13, wherein the process further comprises:
transmitting an inquiry to the supplier to thereby acquire request format information regarding a request format necessary for acquiring a response result having a specific response format.

17. The medium as defined in claim 16, wherein
during the redesignation, when it is determined as a result of the comparison that the response result does not satisfy the response format, at least the request format is redesignated on the basis of the request format information.

18. The medium as defined in claim 13, wherein the process further comprises:
storing a standard request format or standard response format to be employed with respect to the supplier in general, as well as an individual request format or individual response format corresponding to the redesignated request or response format redesignated by the redesignation section; wherein
during the designation, the request format or the response format is designated in accordance with the standard request format or the standard response format when an individual request format or individual response format for use with respect to the supplier is not stored in the storage, whereas, when an individual request format or individual response format for use with respect to the supplier is stored in the storage, the request format or the response format is designated in accordance with the stored individual request or response format.
